(19) United States
(12) Patent Application Publication
(10) Pub. No.: US 2024/0162536 A1
(43) Pub. Date: May 16, 2024

(54) BATTERY TOP COVER ASSEMBLY

(71) Applicant: Ningbo Zhenyu Auto Parts Co., Ltd., Ningbo (CN)

(72) Inventors: Shiya He, Ningbo (CN); Junfeng Lai, Ningbo (CN); Haolin Chen, Ningbo (CN)

(21) Appl. No.: 18/312,784

(22) Filed: May 5, 2023

(30) Foreign Application Priority Data
Nov. 10, 2022 (CN) 202211403730.7
Nov. 10, 2022 (CN) 202211406487.4
Nov. 10, 2022 (CN) 202222991204.9

(51) Int. Cl. H01M 50/15; H01M 50/176; H01M 50/184; H01M 50/186; H01M 50/383; H01M 50/627

(52) U.S. Cl. CPC H01M 50/15; H01M 50/176; H01M 50/184; H01M 50/186; H01M 50/383; H01M 50/627; H01M 10/0525; H01M 2220/20

(57) ABSTRACT

The disclosure provides a battery top cover assembly, comprising top cover plate and a conductive terminal structure. Connectors are formed on a bottom surface of the conductive terminal structure, and the connectors are fitted in a connecting hole of the top cover plate. Outer peripheral walls of the connectors are in contact with and welded with inner peripheral walls of the connectors, so that the conductive terminal structure is fixedly connected to the top cover plate. The independently manufactured and molded terminal structure is welded with the connecting hole of the top cover plate for fixing, which simplifies design and manufacturing process, thereby improving production efficiency and reducing production cost.

### TECHNICAL FIELD

The disclosure pertains to the technical field of manufacturing battery accessories for new energy vehicles, and specifically pertains to a battery top cover assembly.

### BACKGROUND

Power battery is an important component of new energy vehicles. The existing new energy vehicles mostly use lithium-ion batteries as power batteries. For power lithium batteries, in addition to key components such as battery cells and BMS, battery case structure is also an important safety factor. Among them, terminal is an integral part of a battery module. The traditional assembly method of the terminal comprises assembling the terminal into a connecting hole, and then forming a relative complex connection structure between the terminal and a top cover by welding, riveting or injection molding to fixedly connecting the terminal on the top cover. However, the process of forming a connection structure is relatively complicated, and material properties of the top cover need to be considered, which makes the design and manufacturing process of the battery top cover cumbersome, resulting in the problem of low efficiency and high production cost in manufacturing and molding of the battery top cover.

### SUMMARY

The object of the disclosure is to design a battery top cover assembly to solve the technical problems, and its specific implementation is as follows.

The battery top cover assembly of the disclosure comprises a top cover plate and a conductive terminal structure, and the conductive terminal structure is fitted in a terminal mounting position on the top cover plate; the terminal mounting position comprises a connecting hole, the connecting hole is provided on the top cover plate in a penetrating manner, connectors arranged continuously or at intervals are formed on a bottom surface of the conductive terminal structure, and the connectors are formed by extending the bottom surface of the conductive terminal structure downwards; and the connectors are fitted in the connecting hole, and outer peripheral walls of the connectors are in contact with and welded with an inner peripheral wall of the connecting hole, so that the conductive terminal structure is fixedly connected to the top cover plate.

According to the battery top cover assembly, a positioning groove is formed by recessing a portion of the top cover plate located at the terminal mounting position, the connecting hole is arranged on a bottom surface of the positioning groove in a penetrating manner, a bottom of the conductive terminal structure is placed in the positioning groove, an inner peripheral wall of the positioning groove is arranged in contact with an outer peripheral wall of the conductive terminal structure, and the bottom surface of the conductive terminal structure is arranged in contact with the bottom surface of the positioning groove.

According to the battery top cover assembly, the conductive terminal structure comprises a terminal fixture, a terminal, a sealing ring and an insulator; the terminal fixture comprises a ring bottom and a ring wall formed on a top surface of the ring bottom; a terminal fixing cavity in communication with a positioning hole on the ring bottom is formed between the top surface of the ring bottom and the ring wall; the connectors are formed on a bottom surface of the ring bottom, the terminal and the sealing ring are placed in the terminal fixing cavity, a terminal fixing portion of the terminal is positioned in an inner hole of the sealing ring, an outer peripheral wall of the terminal fixing portion of the terminal is arranged in contact with an inner peripheral wall of the sealing ring, and the sealing ring is located between the terminal fixing portion of the terminal and an inner bottom surface of the terminal fixing cavity; the insulator is arranged to at least partially cover the terminal, and the insulator is at least partially located between an outer peripheral wall of a terminal portion of the terminal and an inner peripheral wall of the ring wall; and the insulator and the terminal fixing portion of the terminal are arranged in concave-convex fit, the terminal fixture and the insulator are arranged in concave-convex fit, and a first restricting portion on the ring wall is in fit with a second restricting portion on the insulator, so that the insulator, the sealing ring and the terminal are all fixedly connected in the terminal fixing cavity, and a top surface of the terminal portion of the terminal is exposed to the outside.

According to the battery top cover assembly, a concave cavity is formed on an inner wall of the insulator, convex portions arranged continuously or at intervals are formed on the terminal fixing portion of the terminal along a circumference of the outer peripheral wall of the terminal fixing portion, the convex portions are embedded in the concave cavity, positioning convexes are formed on an inner wall of the concave cavity, positioning concaves are formed on the convex portions, and the positioning convexes are correspondingly embedded in the positioning concaves.

According to the battery top cover assembly, a stepped surface is formed on the insulator, the stepped surface is the first restricting portion, the insulator is preformed, or the insulator is formed by performing injection molding and encapsulation treatment on the terminal; a pressure is applied to the terminal, so that the sealing ring is bent at a top of the ring wall in a compressed state to form a riveting body, and the riveting body is pressed on the stepped surface of the insulator, so that the terminal and the sealing ring are fixedly connected in the terminal fixing cavity of the terminal fixture; and the riveting body is the second restricting portion, and an outer peripheral wall of the terminal fixture is arranged in contact with the inner peripheral wall of the positioning groove.

According to the battery top cover assembly, a plurality of protrusions are formed on an inner wall of the terminal fixing cavity, a plurality of recesses are formed on an outer wall of the insulator, and the protrusions are correspondingly embedded in the recesses.

According to the battery top cover assembly, the sealing ring comprises a sealing ring sheet and a sealing ring body formed on a bottom surface of the sealing ring sheet; an outer wall of the sealing ring body is in contact with an inner wall of the positioning hole on the ring bottom, the sealing ring sheet is located between the convex portions and the ring bottom in a compressed state, a convex ring is formed on the top surface of the ring bottom, a ring groove is formed on the bottom surface of the sealing ring sheet, and the convex ring is embedded in the ring groove; and the terminal fixing portion of the terminal is positioned in an inner hole of the sealing ring sheet, and the outer peripheral wall of the terminal fixing portion of the terminal is arranged in contact with an inner hole wall of the sealing ring sheet, so that the terminal fixing portion of the terminal and the ring bottom are sealed.

According to the battery top cover assembly, the battery top cover assembly further comprises a lower plastic part, the lower plastic part is fixed on a bottom surface of the top cover plate, and the top cover plate is provided with an electrolyte injection port and an explosion-proof valve; a through hole positionally corresponding to the positioning hole on the ring bottom, an electrolyte injection hole positionally corresponding to the electrolyte injection port and a vent hole positionally corresponding to the explosion-proof valve are formed on the lower plastic part; and an annular convex is formed by extending an upper port edge of the through hole upwards, and the annular convex is placed in the positioning hole on the ring bottom.

According to the battery top cover assembly, a plurality of limiting grooves are formed on the ring wall; a pressure is applied to the terminal, so that the insulator is injection molded when the sealing ring is in the compressed state; the insulator comprises a terminal covering portion, a ring wall covering portion and limiting portions fitted in the limiting grooves; the terminal covering portion is located between the terminal and the inner peripheral wall of the ring wall, and the ring wall covering portion covers an outer side wall of the ring wall, so that an outer peripheral wall of the ring wall covering portion is arranged in contact with the inner peripheral wall of the positioning groove; and the limiting portions are formed on an outer wall of the terminal covering portion or an inner wall of the ring wall covering portion, or the limiting portions penetrate through the limiting grooves and are then connected to the terminal covering portion and the ring wall covering portion respectively, and the terminal covering portion, the ring wall covering portion and the limiting portions are combined to form an integral insulator.

According to the battery top cover assembly, the first restricting portion is flanges formed on the outer peripheral wall of the ring wall and arranged continuously or at intervals, and depressions arranged continuously or at intervals are formed on the inner side wall of the ring wall covering portion, and the flanges are embedded in the depressions.

Compared with the prior art, the battery top cover assembly designed by the disclosure has the following beneficial effects:

1. The conductive terminal structure manufactured and molded independently is used, and the conductive terminal structure is welded with the connecting hole of the top cover plate via the connectors for fixing, thus realizing modular assembly of the battery top cover without considering material properties of the top cover plate (e.g., ductility), which simplifies design and manufacturing process of the battery top cover to improve manufacturing efficiency of the battery top cover and reduces manufacturing cost accordingly.

2. The convex ring is embedded in the ring groove, and the convex portions press the sealing ring sheet, which improves performance of sealing between the terminal and the ring bottom, so that the sealing performance of the injection molded terminal can meet the design requirements.

3. The convex portions are arranged in fit with the concave cavity, which prevents the terminal from playing up and down axially after the terminal is fixedly connected in the terminal fixing cavity.

4. A plurality of limiting grooves are formed on the terminal fixture, so that after the insulator is formed, the limiting portions of the insulator are located in the limiting grooves, so as to increase the torque and prevent relative rotation between the insulator and the terminal fixture, meet the product function and comply with the design requirements.

5. The positioning convexes are correspondingly embedded in the positioning concaves to increase the torque and prevent the relative rotation between the terminal and the insulator, and the protrusions are embedded in the recesses to prevent the relative rotation between the insulator and the terminal fixture, which meet the product function and comply with the design requirements.

6. The riveting body is formed so as to prevent the terminal assembled into the terminal assembly cavity from falling off.

### BRIEF DESCRIPTION OF THE DRAWINGS

FIG. 1 is a schematic structural view of an integral battery top cover assembly (1);

FIG. 2 is an enlarged view of A;

FIG. 3 is an enlarged view of B;

FIG. 4 is a schematic structural view of the integral battery top cover assembly (2);

FIG. 5 is a schematic structural view of the integral battery top cover assembly (3);

FIG. 6 is an exploded view of a battery top cover (1);

FIG. 7 is an exploded view of the battery top cover (2);

FIG. 8 is a schematic structural view of a split battery top cover assembly (1);

FIG. 9 is a schematic structural view of the split battery top cover assembly (2);

FIG. 10 is a schematic structural view of the split battery top cover assembly (3);

FIG. 11 is a sectional view of a conductive terminal structure (1);

FIG. 12 is an exploded view of the conductive terminal structure (1);

FIG. 13 is an exploded view of the conductive terminal structure (2);

FIG. 14 is a schematic structural view of a battery top cover assembly (1);

FIG. 15 is an enlarged view of C;

FIG. 16 is a partial schematic structural view of the battery top cover assembly;

FIG. 17 is an exploded view of the battery top cover (3);

FIG. 18 is an exploded view of the battery top cover (4);

FIG. 19 is a sectional view of the conductive terminal structure (2);

FIG. 20 is an exploded view of the conductive terminal structure (3);

FIG. 21 is an exploded view of the conductive terminal structure (4);

FIG. 22 is a partial view of a top cover structure (1);

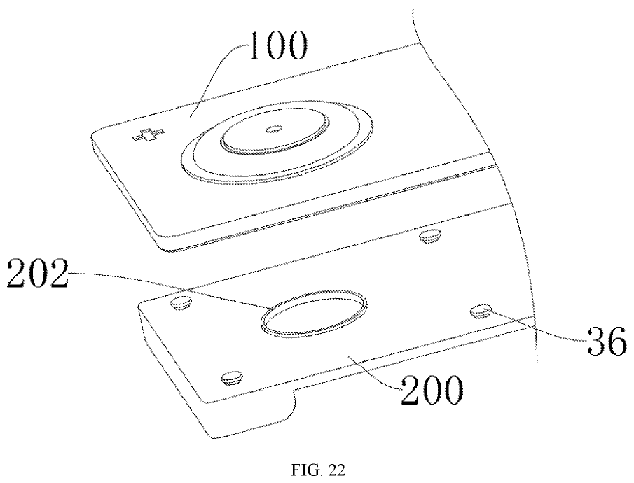

FIG. 23 is a partial view of the top cover structure (2); and

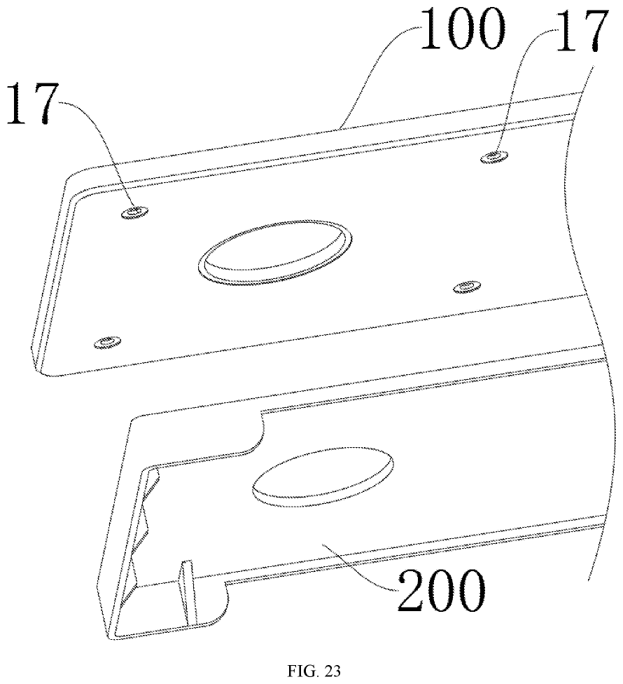

FIG. 24 is a sectional view of the top cover structure.

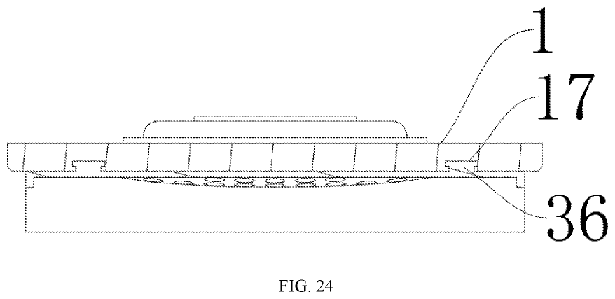

### DESCRIPTION OF THE EMBODIMENTS

The technical schemes of the embodiments of the disclosure will be described clearly and completely below with reference to the accompanying drawings in the embodiments of the disclosure, and it is obvious that the embodiments described are only some, instead of all, of the embodiments of the disclosure. All other embodiments obtained by those skilled in the art based on the embodiments of the disclosure fall within the scope of the disclosure.

### EMBODIMENTS

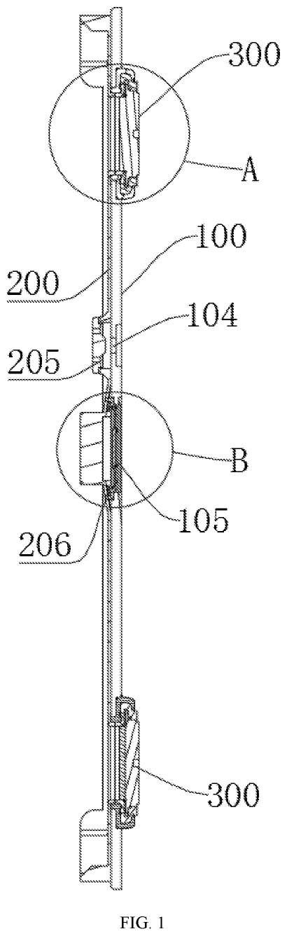

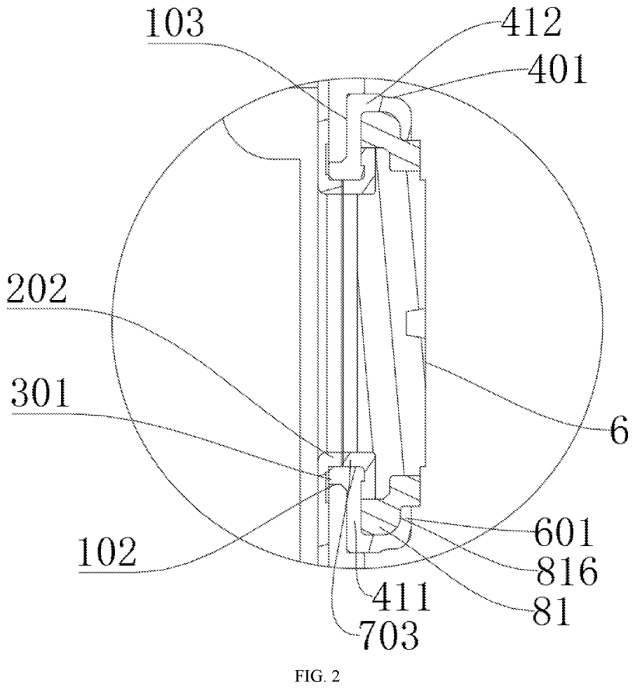

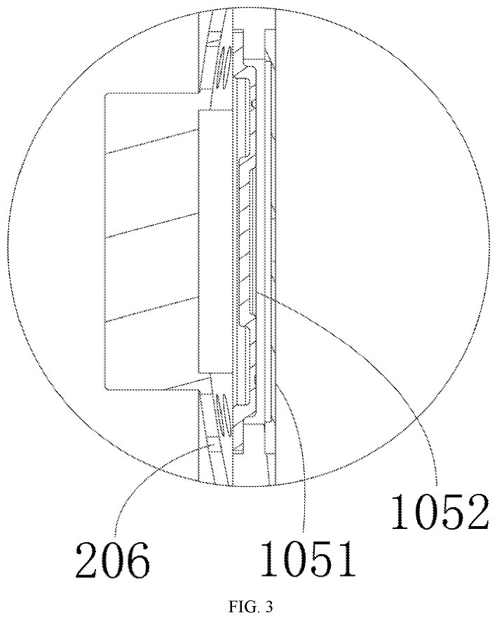

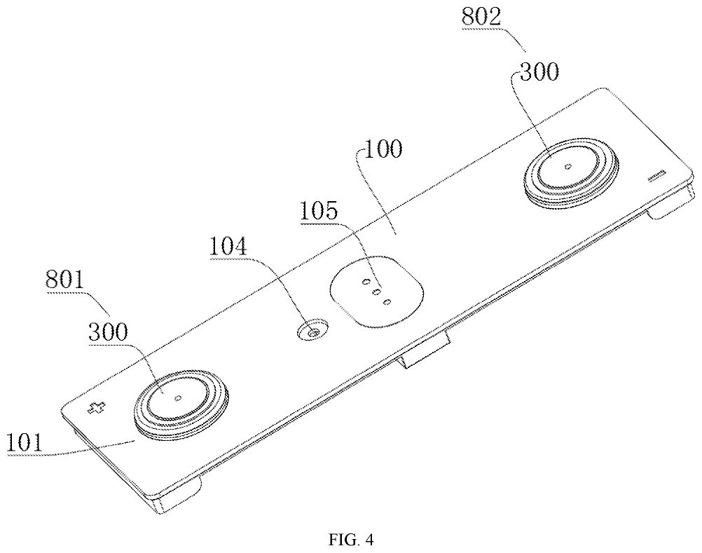

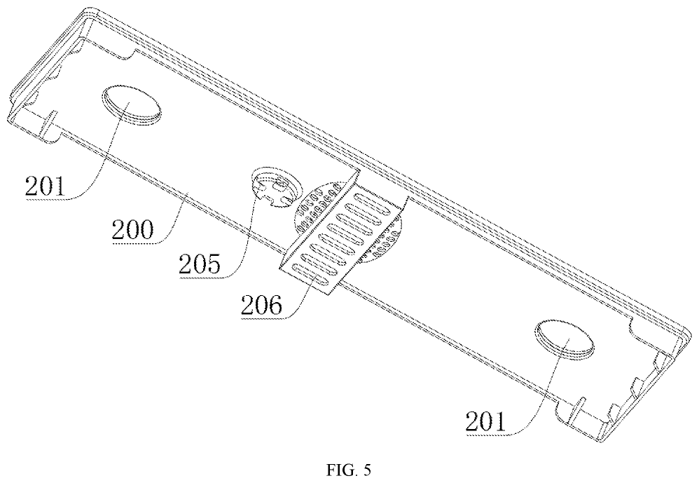

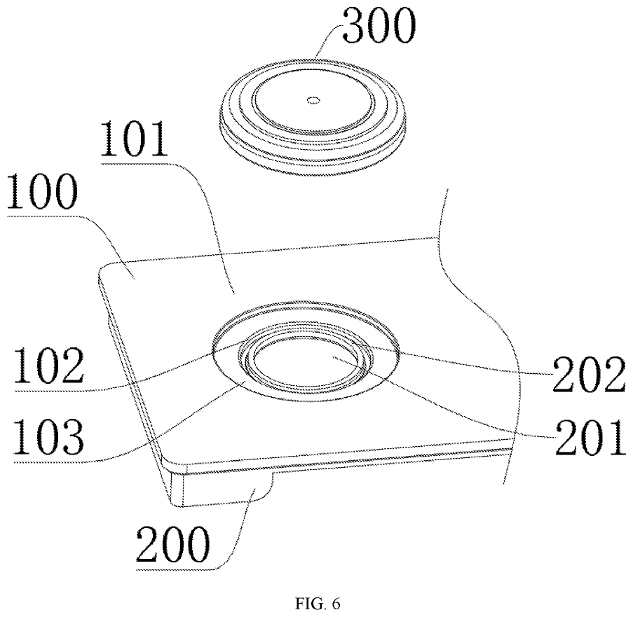

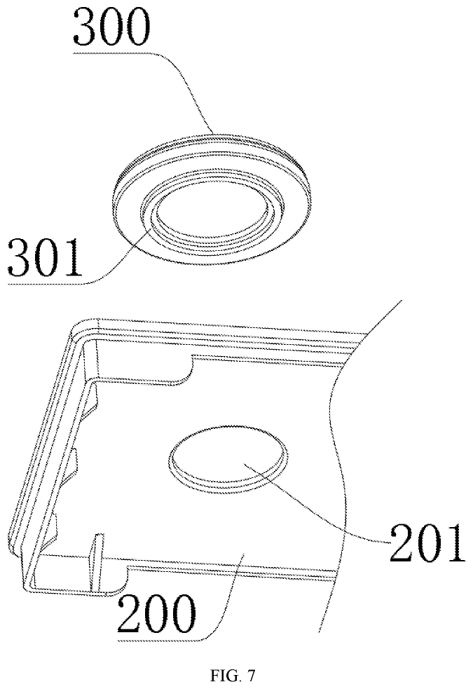

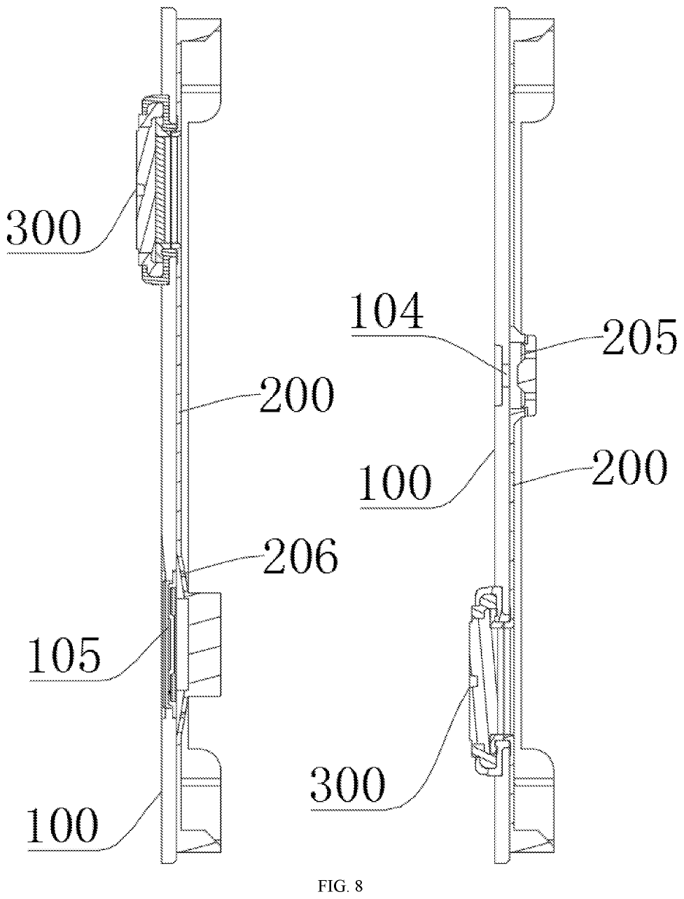

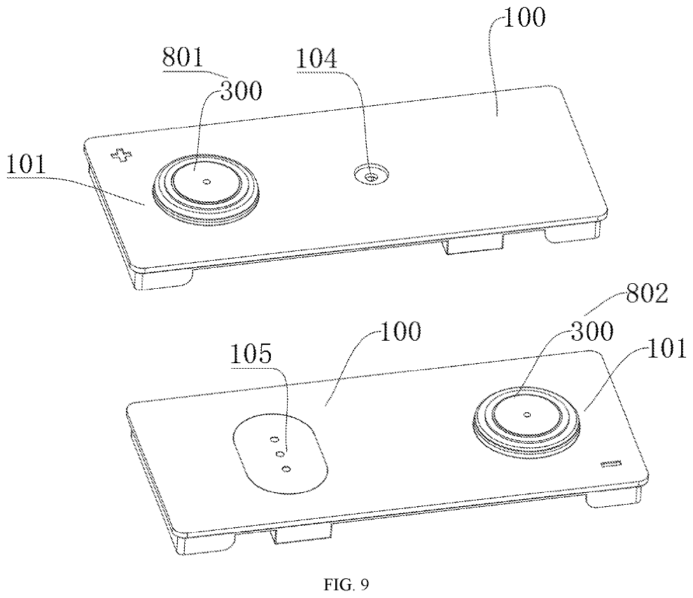

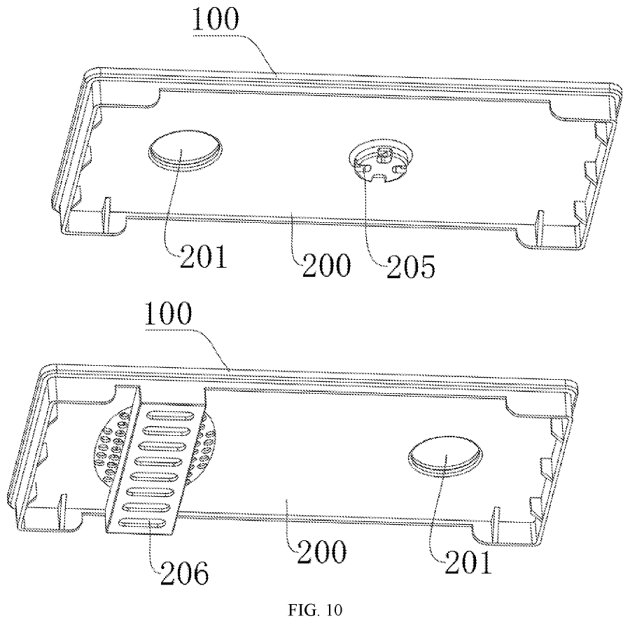

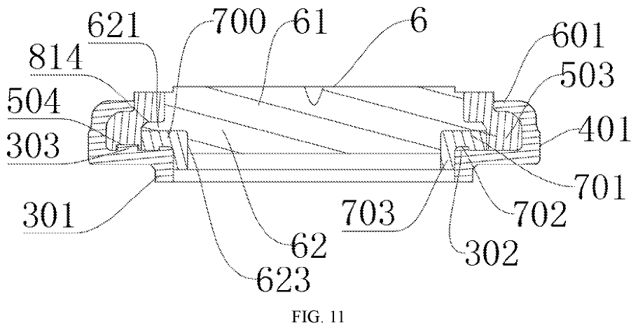

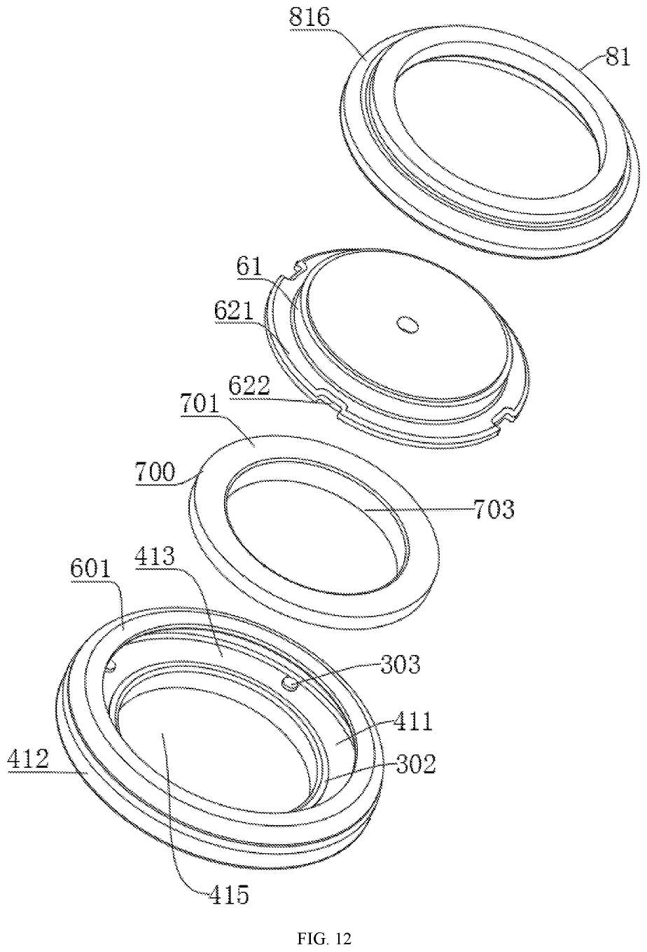

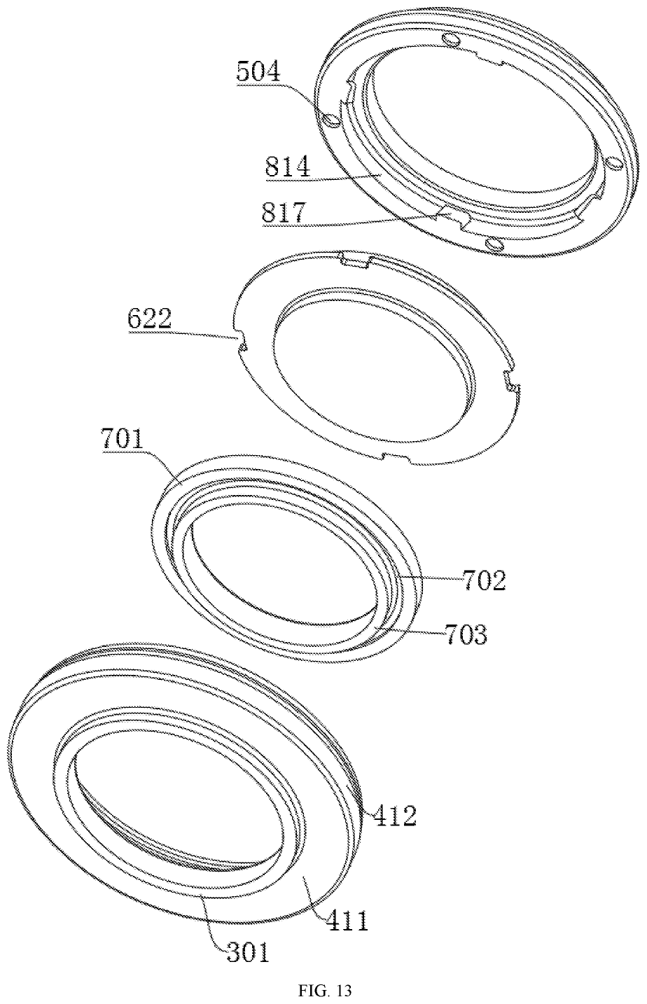

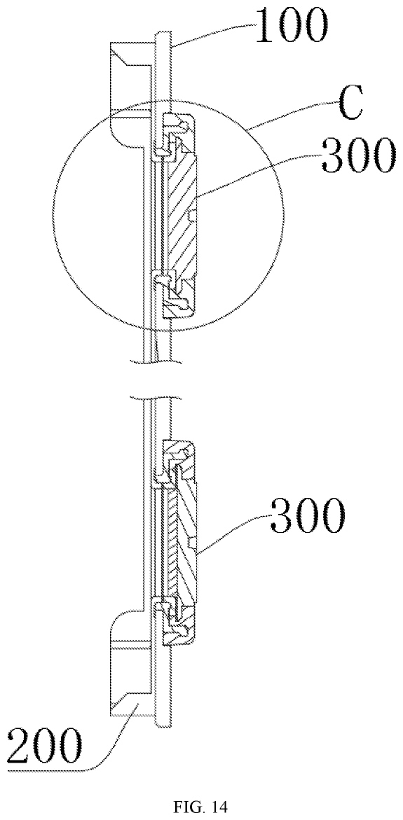

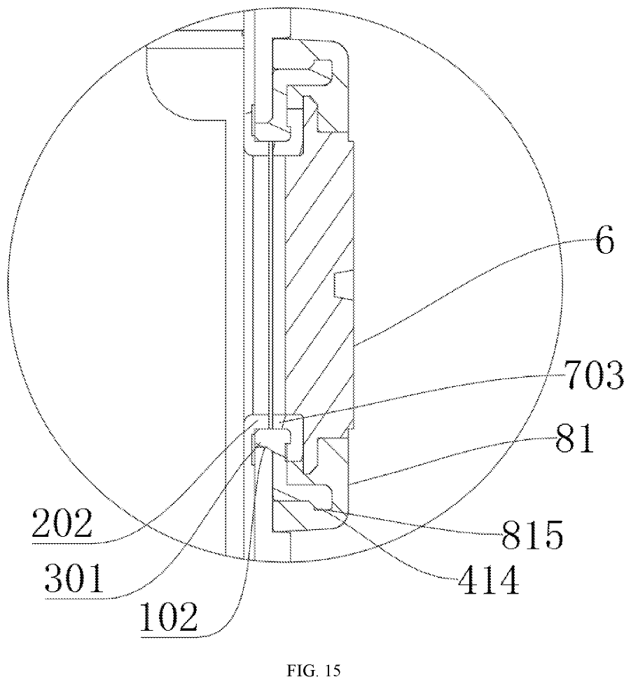

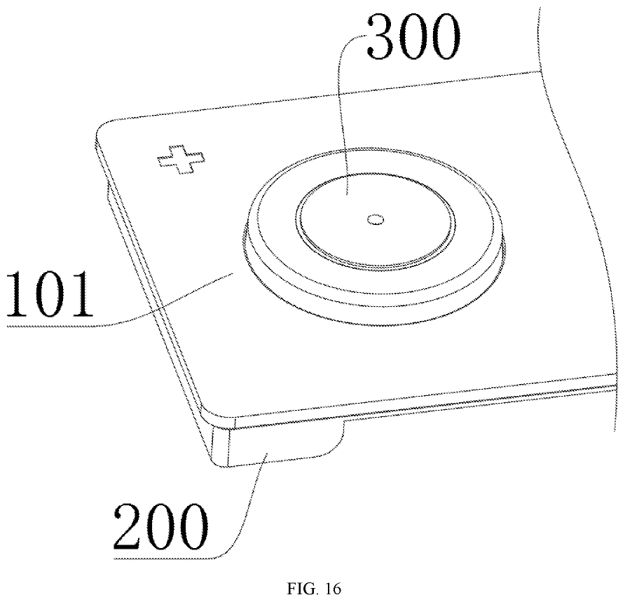

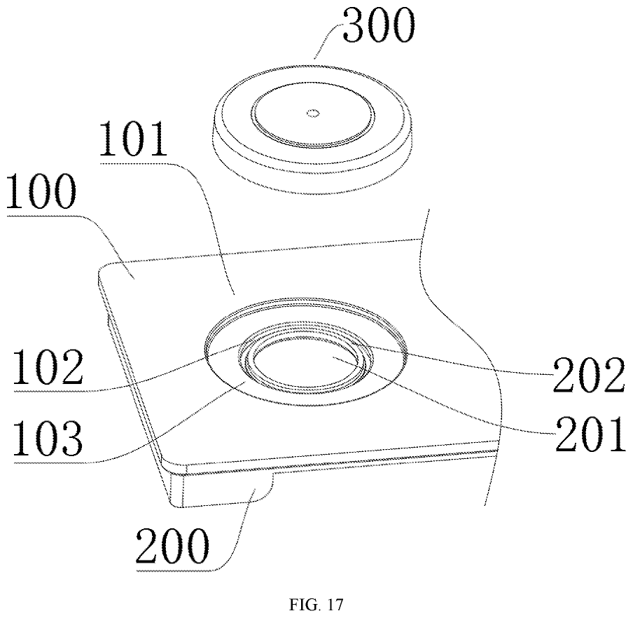

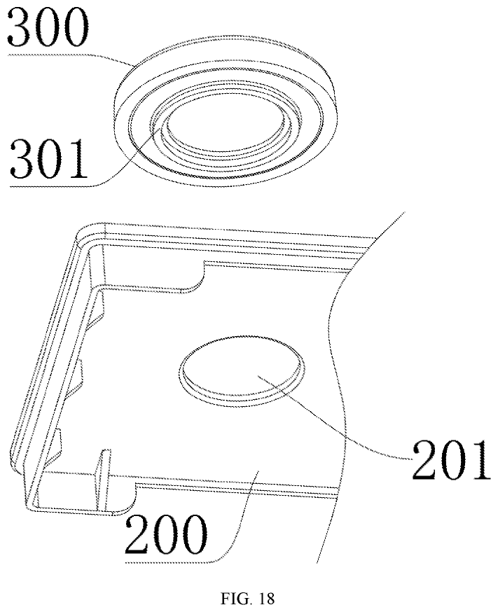

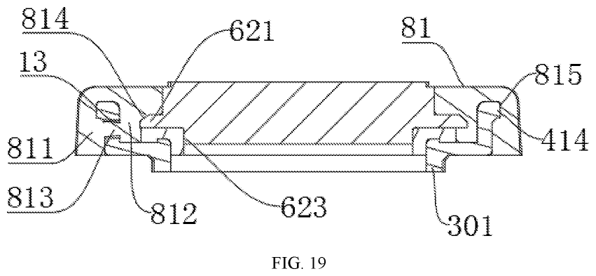

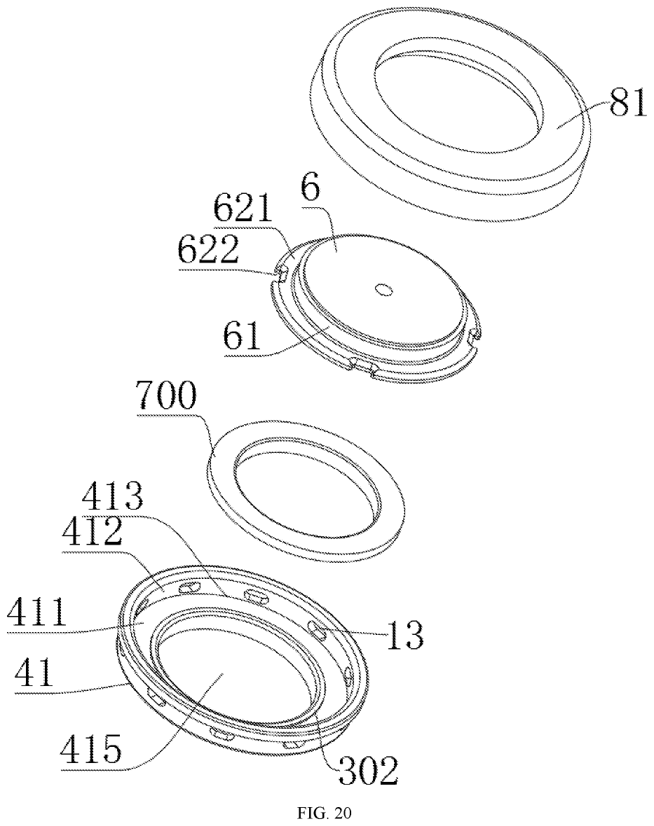

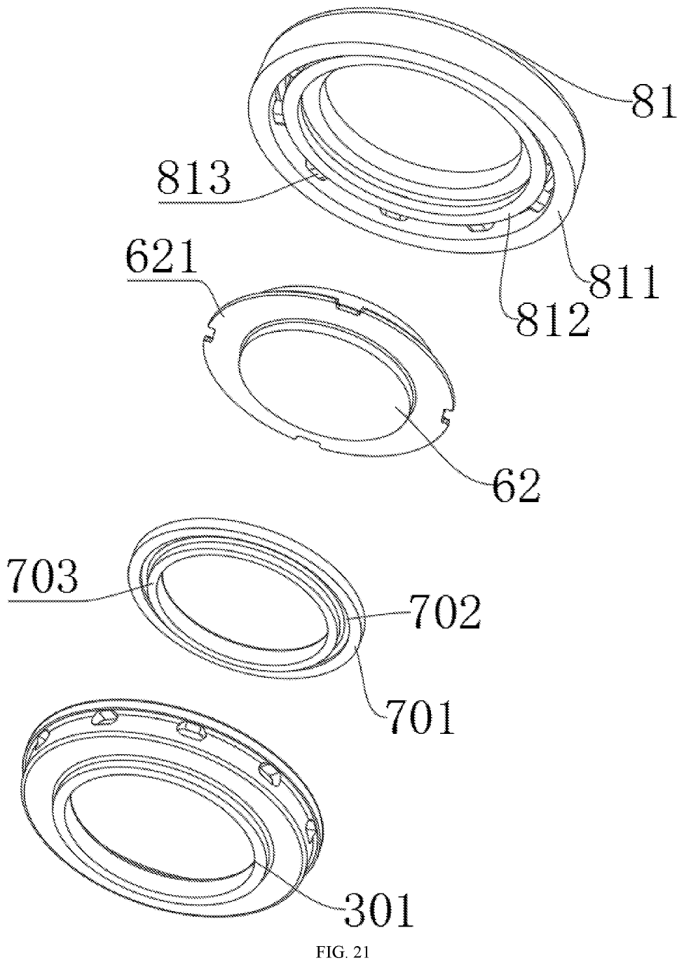

As shown in FIGS. 1-21, the battery top cover assembly described in the present embodiment comprises a top cover plate 100, and two terminal mounting positions 101 on a same top cover plate 100 are respectively fitted with a positive electrode assembly 801 and a negative electrode assembly 802 to form an integral battery top cover assembly, or two terminal mounting positions 101 on different top cover plates 100 are respectively fitted with the positive electrode assembly 801 and the negative electrode assembly 802 to form a split battery top cover assembly; the positive electrode assembly 801 or the negative electrode assembly 802 comprises a conductive terminal structure 300 and connectors 301 formed on a bottom surface of the conductive terminal structure 300; the connectors 301 are formed by extending the bottom surface of the conductive terminal structure 300 downwards; the terminal mounting position 101 comprises a connecting hole 102, the connectors 301 are placed in the connecting hole 102, and outer walls of the connectors 301 are in contact with and welded by laser welding with an inner wall of the connecting hole 102 for fixing; the connectors 301 are preferably arranged in a continuous annular structure, so that the connectors 301 can be fully welded with the connecting hole 102, which makes mounting between the conductive terminal structure 300 and the top cover plate 100 more stable and reliable, and results in a power battery top cover with relatively good performance and structure; alternatively, a plurality of connectors 301 are arranged at intervals in an annular array to form an annular structure; and the top cover plate 100 is an aluminum top cover plate 100, and generally the connecting hole 102, the connectors 301 in the annular structure and the conductive terminal structure 300 can be square or circular shape.

In the present embodiment, a positioning groove 103 is provided on the top cover plate 100 at the terminal mounting position 101, and the connecting hole 102 is provided on a bottom surface of the positioning groove 103 in a penetrating manner; and when the conductive terminal structure 300 is at least partially placed in the positioning groove 103, an inner peripheral wall of the positioning groove 103 is arranged in contact with an outer peripheral wall of the conductive terminal structure 300, and the bottom surface of the conductive terminal structure 300 is arranged in contact with the bottom surface of the positioning groove 103, the conductive terminal structure 300 is positioned before welding to prevent the conductive terminal structure 300 from moving on the top cover plate 100, so that the conductive terminal structure 300 is welded reliably on the top cover plate 100, and the conductive terminal structure 300 is precisely and reliably positioned on the top cover plate 100.

In the present embodiment, the conductive terminal structure 300 comprises a terminal 6, a sealing ring 700, a terminal fixture 401 and an insulator 81; the terminal fixture 401 is made of an aluminum material, that is, an aluminum annular structure; the terminal fixture 401 comprises a ring bottom 411 and a ring wall 412 formed on the ring bottom 411; a terminal fixing cavity 413 in communication with a positioning hole 415 on the ring bottom 411 is formed between a top surface of the ring bottom 411 and the ring wall 412, and the terminal 6 and the sealing ring 700 are placed in the terminal fixing cavity 413; a terminal fixing portion 62 of the terminal 6 is positioned in an inner hole of the sealing ring 700, and an outer peripheral wall of the terminal fixing portion 62 of the terminal 6 is arranged in contact with an inner peripheral wall of the sealing ring 700, so that the terminal fixing portion 62 can be reliably positioned in the terminal fixing cavity 413 before performing injection molding on the ring wall 412 and the terminal 6 or before riveting a top of the ring wall 412; the sealing ring 700 is located between the terminal fixing portion 62 of the terminal 6 and an inner bottom surface of the terminal fixing cavity 413; the insulator 81 is arranged to at least partially cover the terminal 6, and the insulator 81 is at least partially located between an outer peripheral wall of a terminal portion 61 of the terminal 6 and an inner peripheral wall of the ring wall 412; the insulator 81 and the terminal fixing portion 62 of the terminal 6 are arranged in concave-convex fit, the terminal fixture 401 and the insulator 81 are arranged in concave-convex fit, and a first restricting portion on the ring wall 412 is in fit with a second restricting portion on the insulator 81, so that the insulator 81, the sealing ring 700 and the terminal 6 are all fixedly connected in the terminal fixing cavity 413, and a top surface of the terminal portion 61 of the terminal 6 is exposed to the outside; the insulator 81 is made of a plastic material, and is made of a PPS material, and the insulator 81 is arranged to only cover the terminal portion 61 of the terminal 6 or arranged to protect and cover both the terminal portion 61 of the terminal 6 and the ring wall 412; and the terminal 6 in the positive electrode assembly 801 is made of an aluminum material, and the terminal 6 in the negative electrode assembly 802 is made of a copper-aluminum alloy material, and the terminal portion 61 of the terminal 6 is a cylindrical structure.

In the present embodiment, a concave cavity 814 is formed on an inner wall of the insulator 81, convex portions 621 arranged continuously or at intervals are formed on the terminal fixing portion 62 of the terminal 6 along a circumference of the outer peripheral wall of the terminal fixing portion 62, the convex portions 621 are embedded in the concave cavity 814 for fixing, and the convex portions 621 are in fit with the sealing ring 700 to axially limit the terminal 6 and prevent axial up-down play of the terminal 6. Positioning convexes 817 are formed on an inner wall of the concave cavity 814, positioning concaves 622 are formed on edges of the convex portions 621, and the positioning convexes 817 are correspondingly embedded in the positioning concaves 622, so that the first terminal 6 is radially limited in the terminal fixing cavity 413, so that a torque between the terminal 6 and the insulator 81 increases, and relative rotation between the terminal 6 and the insulator 81 is further prevented. The continuous convex portions 621 are convex portions in an annular structure, or the convex portions 621 arranged at intervals are a plurality of convex portions 621 arranged in an annular array on the outer peripheral wall of the terminal fixing portion 62 of the terminal 6.

In the present embodiment, the sealing ring 700 comprises a sealing ring sheet 701 and a sealing ring body 703 formed on a bottom surface of the sealing ring sheet 701; an outer wall of the sealing ring body 703 is in contact with an inner wall of the positioning hole 415 on the ring bottom 411; the sealing ring sheet 701 is located between the convex portions 621 and the ring bottom 411 in a compressed state; a convex ring 302 is formed on the top surface of the ring bottom 411, a ring groove 702 is formed on the bottom surface of the sealing ring sheet 701, and the convex ring 302 is embedded in the ring groove 702; the terminal fixing portion 62 of the terminal 6 is positioned in an inner hole of the sealing ring sheet 701, and the outer peripheral wall of the terminal fixing portion 62 of the terminal 6 is arranged in contact with an inner hole wall of the sealing ring sheet 701, so that the terminal fixing portion 62 of the terminal 6 and the ring bottom are sealed; the convex ring 302 is embedded in the ring groove 702, so that the sealing ring sheet 701 is limited on the ring bottom 411, and performance of sealing between the sealing ring sheet 701 and the ring bottom 411 is improved; the sealing ring body 703 is arranged, so that the sealing ring 700 is positioned and mounted through the positioning hole 415 on the ring bottom 411 before injection molding, which prevents displacement and improves structural stability of the terminal structure 300; the sealing ring 700 is made of a fluororubber material; an annular recess 623 is formed on the terminal fixing portion 62 of the terminal 6, and an upper inner wall of the annular recess 623 is arranged flush with bottom surfaces of the convex portions 621, so that the sealing ring sheet 701 is at least partially placed in the annular recess 623; a top surface of the sealing ring 700 is arranged in close contact with the bottom surfaces of the convex portions 621 and the upper inner wall of the annular recess 623, so that the terminal 6 is reliably positioned before injection molding on the ring wall 412 and the terminal 6 or riveting the top of the ring wall 412; and a portion of terminal fixing portion 62 positioned in the sealing ring 700 is generally circular, and correspondingly, the positioning hole 415 on the ring bottom 411, the convex ring 302, the ring groove 702 and the sealing ring body 703 are all arranged in circular shape.

In the present embodiment, the battery top cover assembly further comprises a lower plastic part 200, a plurality of T-shaped bosses 36 are formed on a top surface of the lower plastic part 200, a plurality of T-shaped grooves 17 are formed on a bottom surface of the top cover plate 100, and the T-shaped bosses 36 are molded on the T-shaped grooves 17 by heat fusion, so that the lower plastic part 200 is fixed on the bottom surface of the top cover plate 100; the top cover plate 100 is provided with an electrolyte injection port 104 and an explosion-proof valve 105; a through hole 201 positionally corresponding to the positioning hole 415 on the ring bottom 411, an electrolyte injection hole 205 positionally corresponding to the electrolyte injection port 104 and a vent hole 206 positionally corresponding to the explosion-proof valve 105 are formed on the lower plastic part 200; an annular convex 202 is formed by extending an upper port edge of the through hole 201 upwards, and the annular convex 202 is placed in the positioning hole 415 on the ring bottom 411; and the lower plastic part 200 is made of a PPS material, the explosion-proof valve 105 is composed of a diaphragm 1051 and a rupture disc 1052 with an annular indentation or a C-shaped indentation, the diaphragm and the rupture disc 1052 are welded and fixed in an explosion-proof hole of the top cover plate 100, and the diaphragm is located above the rupture disc 1052.

When the insulator 81 is arranged to only cover the terminal portion 61 of the terminal 6, the insulator 81 is preformed, or the insulator 81 is formed by performing injection molding and encapsulation treatment on the terminal 6, and the terminal 6 and the insulator 81 are combined to form an independent terminal assembly; a stepped surface 816 is formed on the insulator 81, and the stepped surface 816 is the first restricting portion; after the terminal assembly is assembled into the terminal fixing cavity 413, a pressure is applied to the terminal 6, so that the sealing ring 700 is bent at a top of the ring wall 412 toward the terminal 6 in a compressed state to form a riveting body 601, the riveting body 601 is formed by riveting the top of the ring wall 412 by a riveting apparatus, and the riveting body 601 is pressed on the stepped surface 816 of the insulator 81, so that the terminal 6 and the sealing ring 700 are fixedly connected in the terminal fixing cavity 413 of the terminal fixture 401; the riveting body 601 is the second restricting portion, and an outer peripheral wall of the terminal fixture 401 is arranged in contact with the inner peripheral wall of the positioning groove 103, so that after the terminal structure 300 is reliably positioned in the positioning groove 103, it is convenient to perform the next welding between the connecting hole 102 and the connector 301 to form a riveted terminal, and after the terminal 6 of the riveted terminal is fixedly connected to the terminal fixture 401, the sealing ring can reach 30% compression, thereby meeting the airtightness requirements; and the top surface of the terminal portion 61 of the terminal 6 is higher than a top surface of the insulator 81, so that the top surface of the terminal portion 61 of the terminal 6 is exposed.

Preferably, a plurality of protrusions 303 are formed on an inner wall of the terminal fixing cavity 413, a plurality of recesses 504 are formed on an outer wall of the insulator 81, and the protrusions 303 are correspondingly embedded in the recesses 504, which radially limits a plastic part 503 and the terminal fixing cavity 413 to prevent relative rotation between the insulator 81 and the terminal fixture 401, thereby increasing the torque.

When the insulator 81 is injection molded and covers both the ring wall 412 and the terminal portion 61 of the terminal 6, a plurality of limiting grooves 13 are formed on the ring wall 412; then the terminal 6 and the sealing ring 700 are placed in the terminal fixing cavity 413, at this time, the terminal fixture 401 is placed in an injection molding apparatus, and at this time, a pressure is applied to the terminal 6, so that the insulator 81 is injection molded when the sealing ring 700 is in a compressed state; the insulator 81 comprises a terminal covering portion 812, a ring wall covering portion 811 and limiting portions 813 fitted in the limiting grooves 13; the terminal covering portion 812 is located between the terminal 6 and the inner peripheral wall of the ring wall 412, and the ring wall covering portion 811 covers an outer side wall of the ring wall 412, so that an outer peripheral wall of the ring wall covering portion 811 is arranged in contact with the inner peripheral wall of the positioning groove 103; the limiting portions 813 are formed on an outer wall of the terminal covering portion 812 or an inner wall of the ring wall covering portion 811, or the limiting portions 813 penetrate through the limiting grooves 13 and are then connected to the terminal covering portion 812 and the ring wall covering portion 811 respectively, which forms an injection molded terminal, and after the terminal 6 of the injection molded terminal is fixedly connected to the terminal fixture 401, the sealing ring can reach 30% compression, thereby meeting the airtightness requirements; and the terminal covering portion 812, the ring wall covering portion 811 and the limiting portions 813 are combined to form an integral insulator 81, and the limiting portions 813 are in fit with the positioning groove 103 to radially limit the insulator 81 and the terminal fixture 401, so that the torque between the insulator 81 and the terminal fixture 401 increases, preventing the relative rotation between the insulator 81 and the terminal fixture 401.

Preferably, flanges 414 arranged continuously or at intervals are formed on an outer peripheral wall of the ring wall 412, and the flanges 414 are the first restricting portion; depressions 815 arranged continuously or at intervals are formed on an inner side wall of the ring wall covering portion 811, and the depressions 815 are the second restricting portion; and the flanges 414 are embedded in the depressions 815; and both the flanges 414 and the depressions 815 are arranged in annular shape, which axially limits a metal ring 41 and the insulator 81 and prevents relative axial up-down play of the metal ring 41 and the insulator 81.

What is claimed is:

1. A battery top cover assembly, comprising a top cover plate and a conductive terminal structure, the conductive terminal structure being fitted in a terminal mounting position on the top cover plate;
wherein the terminal mounting position comprises a connecting hole, the connecting hole is provided on the top cover plate in a penetrating manner, connectors arranged continuously or at intervals are formed on a bottom surface of the conductive terminal structure, and the connectors are formed by extending the bottom surface of the conductive terminal structure downwards; and the connectors are fitted in the connecting hole, and outer peripheral walls of the connectors are in contact with and welded with an inner peripheral wall of the connecting hole, so that the conductive terminal structure is fixedly connected to the top cover plate.

2. The battery top cover assembly according to claim 1, wherein a positioning groove is formed by recessing a portion of the top cover plate located at the terminal mounting position, the connecting hole is arranged on a bottom surface of the positioning groove in a penetrating manner, a bottom of the conductive terminal structure is placed in the positioning groove, an inner peripheral wall of the positioning groove is arranged in contact with an outer peripheral wall of the conductive terminal structure, and the bottom surface of the conductive terminal structure is arranged in contact with the bottom surface of the positioning groove.

3. The battery top cover assembly according to claim 2, wherein the conductive terminal structure comprises a terminal fixture, a terminal, a sealing ring and an insulator; the terminal fixture comprises a ring bottom and a ring wall formed on a top surface of the ring bottom; a terminal fixing cavity in communication with a positioning hole on the ring bottom is formed between the top surface of the ring bottom and the ring wall; the connectors are formed on a bottom surface of the ring bottom, the terminal and the sealing ring are placed in the terminal fixing cavity, a terminal fixing portion of the terminal is positioned in an inner hole of the sealing ring, an outer peripheral wall of the terminal fixing portion of the terminal is arranged in contact with an inner peripheral wall of the sealing ring, and the sealing ring is located between the terminal fixing portion of the terminal and an inner bottom surface of the terminal fixing cavity; the insulator is arranged to at least partially cover the terminal, and the insulator is at least partially located between an outer peripheral wall of a terminal portion of the terminal and an inner peripheral wall of the ring wall; and the insulator and the terminal fixing portion of the terminal are arranged in concave-convex fit, the terminal fixture and the insulator are arranged in concave-convex fit, and a first restricting portion on the ring wall is in fit with a second restricting portion on the insulator, so that the insulator, the sealing ring and the terminal are all fixedly connected in the terminal fixing cavity, and a top surface of the terminal portion of the terminal is exposed to the outside.

4. The battery top cover assembly according to claim 3, wherein a concave cavity is formed on an inner wall of the insulator, convex portions arranged continuously or at intervals are formed on the terminal fixing portion of the terminal along a circumference of the outer peripheral wall of the terminal fixing portion, the convex portions are embedded in the concave cavity, positioning convexes are formed on an inner wall of the concave cavity, positioning concaves are formed on the convex portions, and the positioning convexes are correspondingly embedded in the positioning concaves.

5. The battery top cover assembly according to claim 4, wherein a stepped surface is formed on the insulator, the stepped surface is the first restricting portion, the insulator is preformed, or the insulator is formed by performing injection molding and encapsulation treatment on the terminal; a pressure is applied to the terminal, so that the sealing ring is bent at a top of the ring wall in a compressed state to form a riveting body, and the riveting body is pressed on the stepped surface of the insulator, so that the terminal and the sealing ring are fixedly connected in the terminal fixing cavity of the terminal fixture; and the riveting body is the second restricting portion, and an outer peripheral wall of the terminal fixture is arranged in contact with the inner peripheral wall of the positioning groove.

6. The battery top cover assembly according to claim 5, wherein a plurality of protrusions are formed on an inner wall of the terminal fixing cavity, a plurality of recesses are formed on an outer wall of the insulator, and the protrusions are correspondingly embedded in the recesses.

7. The battery top cover assembly according to claim 4, wherein the sealing ring comprises a sealing ring sheet and a sealing ring body formed on a bottom surface of the sealing ring sheet, an outer wall of the sealing ring body is in contact with an inner wall of the positioning hole on the ring bottom, the sealing ring sheet is located between the convex portions and the ring bottom in a compressed state, a convex ring is formed on the top surface of the ring bottom, a ring groove is formed on the bottom surface of the sealing ring sheet, and the convex ring is embedded in the ring groove; and the terminal fixing portion of the terminal is positioned in an inner hole of the sealing ring sheet, and the outer peripheral wall of the terminal fixing portion of the terminal is arranged in contact with an inner hole wall of the sealing ring sheet, so that the terminal fixing portion of the terminal and the ring bottom are sealed.

8. The battery top cover assembly according to claim 7, further comprising a lower plastic part, wherein the lower plastic part is fixed on a bottom surface of the top cover plate, and the top cover plate is provided with an electrolyte injection port and an explosion-proof valve; a through hole positionally corresponding to the positioning hole on the ring bottom, an electrolyte injection hole positionally corresponding to the electrolyte injection port and a vent hole positionally corresponding to the explosion-proof valve are formed on the lower plastic part; and an annular convex is formed by extending an upper port edge of the through hole upwards, and the annular convex is placed in the positioning hole on the ring bottom.

9. The battery top cover assembly according to claim 8, wherein a plurality of limiting grooves are formed on the ring wall; a pressure is applied to the terminal, so that the insulator is injection molded when the sealing ring is in the compressed state; the insulator comprises a terminal covering portion, a ring wall covering portion and limiting portions fitted in the limiting grooves, the terminal covering portion is located between the terminal and the inner peripheral wall of the ring wall, and the ring wall covering portion covers an outer side wall of the ring wall, so that an outer peripheral wall of the ring wall covering portion is arranged in contact with the inner peripheral wall of the positioning groove; and the limiting portions are formed on an outer wall of the terminal covering portion or an inner wall of the ring wall covering portion, or the limiting portions penetrate through the limiting grooves and are then connected to the terminal covering portion and the ring wall covering portion respectively, and the terminal covering portion, the ring wall covering portion and the limiting portions are combined to form an integral insulator.

10. The battery top cover assembly according to claim 9, wherein flanges arranged continuously or at intervals are formed on an outer peripheral wall of the ring wall, and the flanges are the first restricting portion; depressions arranged continuously or at intervals are formed on an inner side wall of the ring wall covering portion, and the depressions are the second restricting portion; and the flanges are embedded in the depressions.
